(19) United States
(12) Patent Application Publication
(10) Pub. No.: US 2006/0083837 A1
(43) Pub. Date: Apr. 20, 2006

(54) Aspartame blend

(76) Inventor: John Gerard Monfre, Downers Grove, IL (US)

Correspondence Address: GLENN PATENT GROUP, 3475 EDISON WAY, SUITE L, MENLO PARK, CA, 94025, US

(21) Appl. No.: 11/251,321

(22) Filed: Oct. 13, 2005

Related U.S. Application Data
(60) Provisional application No. 60/619,827, filed on Oct. 18, 2004.

(51) Int. Cl. A23L 1/236

(52) U.S. Cl. 426/548

(57) ABSTRACT

A process for preparing an agglomerate of aspartame and a carrier comprises the steps of: (a) providing a premix slurry, comprising aspartame and a binding agent; (b) fluidizing a carrier; and (c) applying the premix slurry of step (a) onto said fluidized carrier to form an agglomerate of said aspartame and said carrier. The invention is also directed to the novel agglomerates prepared by the process of this invention. This invention is also directed to tabletop sweeteners, powdered soft drink mixes and sweetener blends having the above-described agglomerates.

### CROSS REFERENCE TO RELATED APPLICATION

This application claims priority to U.S. provisional patent application Ser. No. 60/619,827, filed 18 Oct. 2004, the contents of which are incorporated herein in their entirety by this reference thereto.

### BACKGROUND OF THE INVENTION

1. Technical Field

The invention relates to a process for preparing agglomerates of L-alpha-aspartyl-L-phenylalanine methyl ester (aspartame) and a carrier.

2. Description of the Prior Art

L-alpha-aspartyl-L-phenylalanine methyl ester (aspartame) is a nutritive sweetener made by joining two amino acids (protein components) L-phenylalanine and L-aspartic acid, with a third component called a methyl ester group. Very little is needed for a sweet taste, making aspartame almost non-caloric. It is 180 to 200 times sweeter than sucrose and is digested as a protein. The components are metabolized normally.

U.S. Pat. No. 6,365,217 discloses a process for preparing an agglomerate of N-[N-(3,3-dimethylbutyl)-L-.alpha.-aspartyl]-L-phenylalanine 1-methyl ester and a carrier comprising the steps of: (a) providing a premix slurry comprising N-[N-(3,3-dimethylbutyl)-L-.alpha.-aspartyl]-L-phenylalanine 1-methyl ester and a binding agent; (b) fluidizing a carrier; and (c) applying the premix solution of step (a) onto said fluidized carrier to form an agglomerate of said N-[N-(3,3-dimethylbutyl)-L-.alpha.-aspartyl]-L-phenylalanine 1-methyl ester and said carrier.

L-alpha-aspartyl-L-phenylalanine methyl ester is not suitable in applications that require prolonged exposure to high temperatures because it loses it sweetness. It also is used successfully in beverages, but does lose its sweetness in liquids over an extended period of time. It is approved for use in any category of food or beverage, including tabletop sweeteners, carbonated soft drinks, refrigerated and non-refrigerated ready to drink beverages, frozen desserts and novelties, puddings and fillings, yogurt type products, baked goods and candies.

The melting point of aspartame is 248 degrees C.

Currently, tabletop sweeteners are agglomerated as a powder onto a powder carrier. For solid products, such as tabletop sugar substitutes, this may be accomplished by forming a dry blend of L-alpha-aspartyl-L-phenylalanine methyl ester with a bulking agent such as, for example, Unidex brand mixture of dextrose (97%) and maltodextrin (3%) available from CPC International. It is common to blend 95-97% by weight Unidex with 3-5% by weight aspartame to provide a tabletop sugar substitute.

In above referenced U.S. Pat. No. 6,365,217, N-[N-(3,3-dimethylbutyl)-L-.alpha.-aspartyl]L-phenylalanine 1-methyl ester (Neotame) is agglomerated as a solution onto a powder carrier. The process of agglomeration using a N-[N-(3,3-dimethylbutyl)-L-.alpha.aspartyl]-L-phenylalanine 1-methyl ester solution, rather than a powder, provides numerous significant advantages including improved content uniformity and ease of processing.

Fluidized bed agglomeration is well known in the art. The process is described in U.S. Pat. Nos. 2,856,290, 3,251,695, and 3,433,644, the disclosures of which are incorporated by reference herein. Typically, in both continuous and batch fluid bed agglomeration processes, finely divided particles are sprayed onto a fluidized bed of particles under moisture and temperature conditions which promote formation of an agglomerate. Often the process involves heating at least one of the components of the agglomerate to a temperature above its melting point.

U.S. Pat. No. 4,554,167 discloses a method for preparing agglomerates of aspartame and acid-containing food mixes. The disclosed agglomeration process does not involve heating one or more of the agglomerate components to a temperature above its melting point. Neither does the disclosed proceed involve dissolving the high intensity sweetener in a solvent prior to formation of the agglomerate.

### SUMMARY OF THE INVENTION

The invention provides a process for preparing an agglomerate of aspartame and a carrier comprising the steps of: (a) providing a premix slurry, comprising aspartame and a binding agent; (b) fluidizing a carrier; and (c) applying the premix of step (a) onto said fluidized carrier to form an agglomerate of said aspartame and said carrier. The invention is also directed to the novel agglomerates prepared by the process of this invention. This invention is also directed to tabletop sweeteners, powdered soft drink mixes and sweetener blends having the above-described agglomerates.

### DETAILED DESCRIPTION OF THE INVENTION

In the agglomeration process of the invention, a premix slurry is formed which comprises aspartame and a binding agent. The premix slurry is preferably formed by adding the aspartame and the binding agent to the same solvent.

Alternatively, the premix slurry may be formed by adding the aspartame and the binding agent to separate solvents, and then combining the two solutions. In the latter approach, the solvent used to dissolve the aspartame may be the same as, or different from, the solvent that is used to dissolve the binding agent. Under either process, the resultant premix is applied onto a fluidized carrier using a fluid bed agglomeration mixer. Preferably, the premix is applied onto the fluidized carrier by spraying the premix onto the fluidized carrier. An agglomerate of aspartame and the carrier is thus formed.

The agglomerates of the invention comprise: (i) an effective sweetener amount of aspartame; (ii) a binding agent; and (iii) a carrier. The binders and carriers employed in the agglomerates of the invention are described in greater detail below.

The agglomeration process of the invention may be performed using a batch fluid bed agglomerator. Other equipment that may be used in the invention include a continuous fluid bed agglomerator or a continuous turbulent flow agglomerator, e.g. Schugi Flex-O-Mix and Turbulizer, Hosokawa Bepex Corp., Minneapolis, Minn.

To prepare the premix slurry, aspartame is added to a solvent. Any solvent in which aspartame is slurried may be used in the invention. Preferably, the solvent is a food grade solvent. Exemplary solvents which may be used in the invention include ethanol, water, isopropanol, methanol, and mixtures thereof, Preferably, the solvent is ethanol.

The binding agent is dissolved in a solvent which may be the same as, or different from, the solvent used to slurry the aspartame. Any solvent in which the particular binding agent chosen dissolves may be used in the invention. Solvents which may be used to dissolve the binding agent include water, ethanol, isopropanol, methanol and mixtures thereof. Preferably, the solvent is a food grade solvent. Most preferably, the solvent is water.

As is readily apparent to those skilled in the art, the premix solution may be prepared by slurrying the aspartame and the binding agent in the same solvent, The solvent may be a single compound, e.g. ethanol, or it may be a mixture of compounds, e.g. ethanol and water. The invention is not limited in the manner of making the premix of the invention.

To effect complete mixing of the premix, the premix may be heated up to about 90 degrees C. As used herein, the term “effect mixing” means blending sufficiently so as to form a mixture. Preferably, the premix solution is heated to between about 30 degrees C. and about 50 degrees C., more preferably between about 35 degrees C. and about 45 degrees C.

The carrier is fluidized and its temperature is adjusted to between about 20 degrees C. and about 50 degrees C. Preferably, the carrier is heated to between about 35 degrees C. and about 45 degrees C. More preferably, the carrier is heated to about 40 degrees C.

The carrier may be placed into a removable bowl of a fluid bed agglomerator. After the bowl is secured to the fluid bed agglomerator, the carrier is fluidized and heated as necessary by adjusting the inlet air temperature. Preferably, the temperature of the inlet air is maintained between 50 degrees C. and 100 degrees C. For example, to heat the fluidized carrier to about 40 degrees C., the inlet air temperature may be adjusted to between 70 degrees C. and 75 degrees C.

Once the fluidized carrier reaches the desired temperature, the premix solution may be applied through the spray nozzle of the fluid bed agglomerator. The premix solution may be sprayed onto the fluidized carrier at any rate which is effective to produce an agglomerate having the desired particle size distribution. Those skilled in the art will recognize that a number of parameters may be adjusted to obtain the desired particle size distribution. After spraying is completed, the agglomerate may be allowed to dry.

Preferably, the agglomerate is allowed to dry until the outlet air temperature reaches 35 degrees C. to 40 degrees C.

Binding agents facilitate the agglomeration of aspartame to the carrier. Any binding agent with sufficient binding strength may be used in the invention. Exemplary binding agents which may be used in the invention include maltodextrin, sucrose, gellan gum, hydroxypropylmethyl cellulose (HPMC), carboxymethyl cellulose (CMC), polyvinyl pyrrolidone (PVP) and mixtures thereof. Preferably, the binding agent is maltodextrin.

The concentration of binding agent in the solution may vary depending on a variety of factors, including the binding strength of the particular binding agent and the particular solvent chosen. When water is the solvent, it is preferable that the concentration of binding agent in the aqueous solution be between about 1% and about 50% by weight. More preferably, the concentration of binding agent in the aqueous solution is between about 5% and about 25% by weight.

The weight ratio of binding agent to L-alpha-aspartyl-L-phenylalanine methyl ester in the premix solution may vary from as low as about 1:10, to as high as about 10:1. Preferably, the weight ratio of binding agent to aspartame is about 5:3.5.

The amount of carrier present in the agglomerates of the invention also may vary over a broad range, depending upon the particular carrier selected, as well as the end use desired. Preferably, the amount of carrier present in the agglomerates of the invention is between about 50 weight percent and about 99.9 weight percent based upon the total amount of the agglomerate. More preferably, the amount of carrier is between about 75 weight percent and about 99 weight percent.

The amount of binding agent present in the agglomerates of the invention also may vary over a broad range, depending upon the particular binding agent selected, as well as the end use desired. Preferably, the amount of binding agent present in the agglomerates of the invention is between about 0.1 weight percent and about 15 weight percent based upon the total amount of the agglomerate. More preferably, the amount of binding agent is between about 1 weight percent and about 7 weight percent.

The amount of aspartame agglomerate that may be present in the tabletop sweeteners of this invention may vary over a broad range. Preferably, the amount of aspartame agglomerate present in the tabletop sweeteners of this invention is between 3 weight percent and about 100 weight percent based upon the total amount of the tabletop sweetener. More preferably, the amount of aspartame agglomerate is between about 70 weight percent and about 100 weight percent.

The amount of blending agent that may be present in the tabletop sweeteners of this invention may vary over a broad range. Preferably, the amount of blending agent present in the tabletop sweeteners of this invention is between about 50 weight percent and about 99 weight percent based upon the total amount of the tabletop sweetener. More preferably, the amount of blending agent is between about 90 weight percent and about 99 weight percent.

The amount of aspartame agglomerate that may be present in the powdered soft drink mixes of this invention may vary over a broad range.

The particle size distribution of the aspatame agglomerate may be determined by sifting the agglomerate through screens of various sizes. For example, the agglomerate may be sifted with screens ranging in size from 14 mesh to 140 mesh or higher. Typically, at least about 65% of the particles of the agglomerate pass through a 40 mesh screen and less than about 20% of the agglomerate particles pass through 100 mesh screen. In general, less than about 70% of the particles of the agglomerate pass through a 60 mesh screen and less than about 5% of the agglomerate particles pass through a 140 mesh screen. Typically, at least 50% of the particles of the agglomerate are between about 60 mesh and 100 mesh in size.

The product may be screened to produce a narrower particle size distribution, if desired. For example, a 14 mesh screen may be used to remove large particles and produce a product of especially good appearance. Particles smaller than 120 mesh may be removed to obtain an agglomerate with improved flow properties. A narrower particle size distribution may be obtained if desired for particular applications.

The particle size distribution of the aspartame agglomerate may be controlled by a variety of factors including the selection of binding agent, the concentration of the binding agent in solution, the spray rate of the spray solution, the atomization air pressure and the particular carrier used. Those skilled in the art will appreciate that a desired particle size distribution may be obtained by varying one or more of the aforementioned factors. For example, increasing the spray rate is known to increase the average particle size.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A tabletop sweetener product obtained by the process comprising the steps of:
(a) providing a premix slurry comprising of L-alpha-aspartyl-L-phenylalanine methyl ester (aspartame), a binding agent, and solvent;
(b) heating the premix slurry of step (a) to a temperature effective to effect mixing of said premix;
(c) fluidizing a carrier; and
(d) applying a premix slurry of step (b) onto said fluidized carrier to form an agglomerate comprising said L-alpha-aspartyl-L-phenylalanine methyl ester (aspartame) on said carrier.

2. The product of claim 1, wherein in step (d), said premix slurry is applied onto said fluidized carrier by spraying the premix slurry onto said fluidized carrier.

3. The product of claim 1, wherein said high intensity sweetener is aspartame L-alpha-aspartyl-L-phenylalanine methyl ester (aspartame) in an amount of from 1% to about 4% of said product.

4. The product of claim 1, wherein said binding agent is maltodextrin in an amount from about 2 weight percent to about 4 weight percent of said product.

5. The product of claim 1, wherein said solvent is water.

6. The product of claim 1, wherein said carrier is dextrose in an amount from about 92 weight percent to about 97 weight percent of said product.

7. The product of claim 1, wherein said carrier is fluidized at a temperature between about 30 degrees C. and about 50 degrees C.

8. The product of claim 1 wherein step (b) comprises heating the premix slurry of step
(a) to between about 35 degrees C. and about 50 degrees C.

9. The product of claim 1, wherein said carrier is present in an amount from about 50 weight percent to about 99.9 weight percent based upon the total amount of said agglomerate.

10. The product of claim 1, wherein said binding agent is present in an amount from about 0.1 weight percent to about 15 weight percent based upon the total amount of said agglomerate.

11. The product of claim 1, wherein said binding agent is present in an amount from about 1 weight percent to about 7 weight percent based upon the total amount of said agglomerate.

12. The product of claim 1, wherein said agglomerate is comprised of particles, more than about 80 percent of which are greater in size than 100 mesh and more than about 95% of which are greater in size than 140 mesh.

13. The product of claim 12, wherein more than about 70 percent of the particles of said agglomerate are smaller in size than 60 mesh.

14. The product of claim 12, wherein at least 50 percent of the particles of said agglomerate are between about 60 mesh and 100 mesh in size.
